(19) United States
(12) Patent Application Publication
(10) Pub. No.: US 2013/0190933 A1
(43) Pub. Date: Jul. 25, 2013

(54) ENERGY EFFICIENT AIR FLOW CONTROL

(71) Applicants: Robert L. DeAngelis, Yorktown Heights, NY (US); Stephen J. Graziano, Washingtonville, NY (US); David Longinott, Rock Tavern, NY (US); Mrunal B. Patwa, Lewisville, TX (US); David J. Pinckney, Newtown, CT (US); David M. Sweeney, New Fairfield, CT (US)

(72) Inventors: Robert L. DeAngelis, Yorktown Heights, NY (US); Stephen J. Graziano, Washingtonville, NY (US); David Longinott, Rock Tavern, NY (US); Mrunal B. Patwa, Lewisville, TX (US); David J. Pinckney, Newtown, CT (US); David M. Sweeney, New Fairfield, CT (US)

(73) Assignee: INTERNATIONAL BUSINESS MACHINES CORPORATION, Armonk, NY (US)

(21) Appl. No.: 13/354,717

(22) Filed: Jan. 20, 2012

(51) Int. Cl. G05B 13/00

(52) U.S. Cl. 700/282

(57) ABSTRACT

An energy efficient air flow control system includes exhaust devices of a building air flow management system. Each of the exhaust devices includes a controller for controlling functions of its respective exhaust device. A first sensor is coupled to each of the exhaust devices and respective controllers. A computer is coupled to the exhaust devices via respective controllers. A second sensor determines a fan speed of a supply air fan, and the second sensor is coupled to the computer. Logic executable by the computer receives user-selected settings for controlling operation of the exhaust devices, collects data from the controllers via corresponding first sensors and from the second sensors, applies the data to the settings, and modifies operation of the system via a controller of at least one of the exhaust devices when, in response to applying the data, it is determined that a condition defined in the settings is met.

### BACKGROUND

The present invention relates to air flow and exhaust systems, and more specifically, to energy-efficient air flow and exhaust system control.

Buildings that heavily rely on air flow and exhaust systems to maintain a safe and comfortable working environment (e.g., chemical laboratories) typically employ a number of exhaust hoods that consume air-conditioned air, and discharge the air, along with any fumes or undesirable elements, to the atmosphere outside the building. A typical exhaust hood may cost several thousand dollars a year to operate in energy costs. For buildings that utilize large numbers of these hoods, the costs of operation in terms of energy consumed and dollars spent can be exorbitant.

### SUMMARY

According to one embodiment of the present invention, a system for providing energy efficient air flow includes exhaust devices disposed in an area defined by a building air flow management system. Each of the exhaust devices includes a controller for controlling functions of respective exhaust devices. A first sensor is communicatively coupled to each of the exhaust devices and respective controllers. A computer is communicatively coupled to the exhaust devices via respective controllers. A second sensor determines a fan speed of a supply air fan. The second sensor is communicatively coupled to the computer. Logic executes on the computer to perform a method. The method includes receiving, at the computer, user-selected settings for controlling operation of the exhaust devices, collecting data from the controllers via corresponding first sensors and from the second sensors, applying the data to the user-selected settings, and modifying operation of the building air flow management system via a respective controller of at least one of the exhaust devices when, responsive to the applying, it is determined that a condition defined in the user-selected settings is met.

According to another embodiment of the present invention, a method for providing energy efficient air flow includes receiving, at a computer, user-selected settings for controlling operation of exhaust devices. Each of the exhaust devices is disposed in an area defined by a building air flow management system and includes a controller for controlling functions of respective exhaust devices. A first sensor is communicatively coupled to each of the exhaust devices and respective controllers, and a second sensor is communicatively coupled to the computer and configured to determine a fan speed of a supply air fan. The method also includes collecting, via logic executable by the computer, data from the controllers via corresponding first sensors and from the second sensors, applying the data to the user-selected settings, and modifying operation of the building air flow management system via a respective controller of at least one of the exhaust devices when, in response to applying the data, it is determined that a condition defined in the user-selected settings is met.

According to a further embodiment of the present invention, a computer program product for providing energy efficient air flow is provided. The computer program product includes a storage medium having instructions embodied thereon, which when executed by a computer cause the computer to implement a method. The method includes receiving user-selected settings for controlling operation of exhaust devices. Each of the exhaust devices is disposed in an area defined by a building air flow management system and includes a controller for controlling functions of respective exhaust devices. A first sensor is communicatively coupled to each of the exhaust devices and respective controllers, and a second sensor is communicatively coupled to the computer and is configured to determine a fan speed of a supply air fan. The method also includes collecting data from the controllers via corresponding first sensors and from the second sensors, applying the data to the user-selected settings, and modifying operation of the building air flow management system via a respective controller of at least one of the exhaust devices when, in response to applying the data, it is determined that a condition defined in the user-selected settings is met.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a system upon which energy efficient air flow processes may be implemented in accordance with an exemplary embodiment; and

FIG. 2 depicts a block diagram of an energy efficient exhaust device contained within the system of FIG. 1; and

FIG. 3 is a flow diagram of a process for implementing an energy efficient air flow system in accordance with an exemplary embodiment.

### DETAILED DESCRIPTION

An energy efficient air flow system and method are provided. The energy efficient air flow system is part of a building's air flow management system that includes supply air flow components, as well as exhaust components as will be described further herein. The energy efficient air flow system networks together exhaust devices disposed within a contained or enclosed environment (e.g., a designated area such as a building, floor, etc.) and automates the operation of the networked exhaust devices in terms of maintaining a desired level of air quality, while balancing positive and negative air flow conditions caused by the combined use of the exhaust devices, building exhaust fans, and building supply air fans. In an exemplary embodiment, the energy efficient air flow system utilizes a damper on the exhaust device as a control valve to regulate both exhaust and air supply functions.

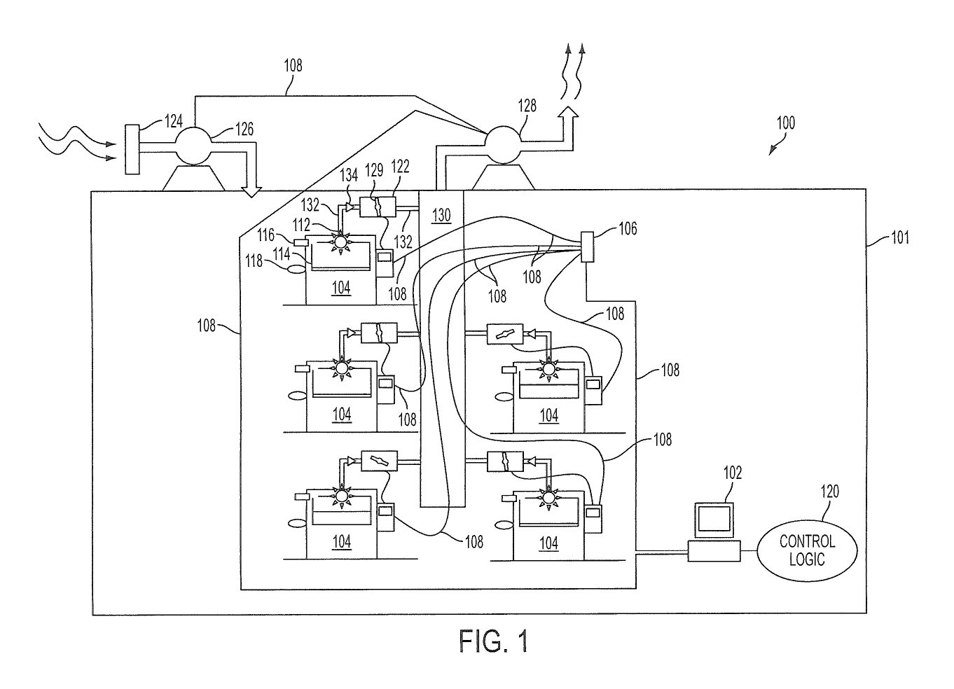

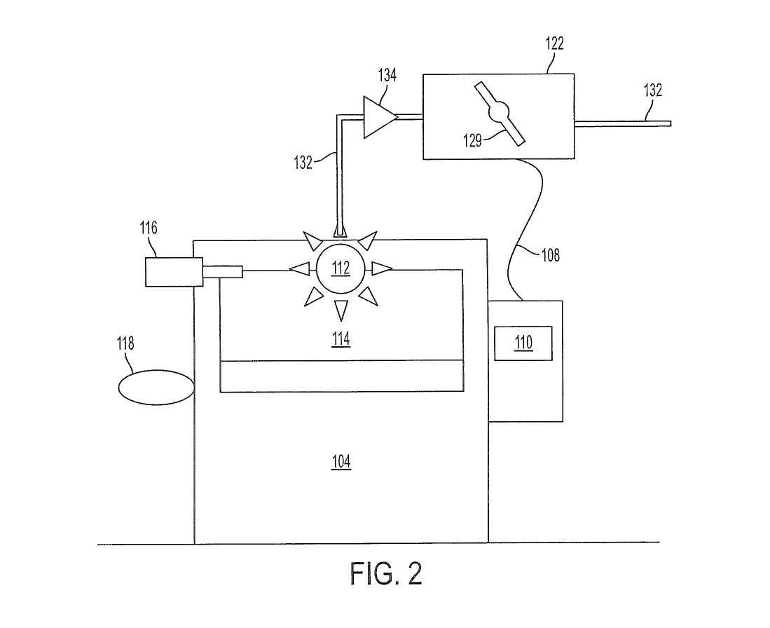

Turning now to FIGS. 1 and 2, a system 100 for implementing exemplary energy efficient air flow in a contained or enclosed environment will now be described. The system 100 is described herein with regard to a chemical laboratory for illustrated purposes only. It will be understood that other types of business uses may be substituted for the chemical laboratory (e.g., manufacturing); thus, the example provided herein is not to be interpreted as limiting in scope.

The system 100 includes a user system 102 communicatively coupled to a multitude of exhaust devices 104 via a network switch 106 and wires 108 within a building 101. The user system 102 may be a general purpose computer. The network switch 106 may be an Ethernet switch that is communicatively coupled to the user system 102 via physical wiring 108. In an alternative embodiment, the network switch 106 may be coupled to the user system 102 using wireless means, such as Bluetooth™-enabled components. Likewise, the exhaust devices 104 may be wirelessly coupled to the network switch 106. Alternatively, other configurations may be implemented in order to realize the advantages of the exemplary embodiments described herein. For example, multiple network switches 106 may be employed throughout a defined area, where each of the network switches 106 manage the communications between a number of exhaust devices 104 and the user system 102.

Each of the exhaust devices 104 may be implemented as a chemical hood exhaust device that includes a motor-controlled damper 122, a hood having a movable sash 114, and a user presence detector 112. The exhaust device 104 also includes a programmable logic hood controller and user interface screen 110 (also referred to herein as “controller”). The controller 110 includes a processor, program logic, and user controls that are configured to perform a variety of operational functions with respect to the exhaust device 104. For example, the controller 110 is configured to open and close the motor-controlled damper 122 under specified conditions (e.g., either by operator command or by instructions received from the user system 102). The movable sash 114 is positioned by a sash motor 118 to permit user access to the hood interior under instructions from the controller 110. The sash 114 may be a clear glass panel that protects an operator. A sash position sensor 116 is used to determine the location of the sash 114 within its range of motion (between an open and closed position). The user presence detector 112 is applied to determine if the hood is actively being used by an operator. This device may be an infra-red (IR) detector, pressure sensitive mat, or other available sensor. The damper 122, user presence detector 112, sash position sensor 116, and sash motor 118 are communicatively coupled to the corresponding exhaust device 104 and to the controller 110 using any coupling means known in the art.

Each exhaust device 104 is physically connected to a corresponding exhaust damper 122 and ductwork 132. Located within the hood is a work area such that chemical fumes produced or released in the work area are directed out or away from the contained area through the exhaust damper 122 and out of the building 101 via the ductwork 132 and an exhaust riser 130, pulled by the motion of the building exhaust fan 128, which is coupled to the exhaust riser 130. An exhaust flow sensor 134 is disposed in the ductwork 132 between the exhaust device 104 and the exhaust damper 122. The exhaust flow sensor 134 measures the amount of air flow (e.g., cubic feet per minute or CFM) processed by the exhaust device 104. While shown in FIG. 1 as a separate element for ease of description, it will be understood that the exhaust sensor 134 may be physically integrated within the damper 122. The amount of air flow directed through the damper 122 may be controlled by a valve 129 in the damper 122 that opens and closes as directed.

While only three sensors (i.e., the sash position sensor 116, the user presence detection sensor 112, and the exhaust flow sensor 134) are shown with respect to the exhaust device 104, it will be understood that additional sensors may be included without departing from the spirit and scope of the invention. For example, in one embodiment, the controller 110 may be coupled to a sensor within the ductwork 132 between the exhaust device 104 and the damper 122 that monitors the amount or concentration level of a chemical contained in exhaust ductwork 132.

An air supply fan 126 provides fresh air to the building 101. This fan 126 is provided with a variable frequency drive (VFD, not shown) which is used to adjust the fan speed and provide energy savings. A supply air flow station 124 is coupled to the air supply fan 126 and measures the volume of outside air entering the building.

The supply air fan 126 and the each communicatively coupled to the user system 102 (e.g., via wiring 108 or using wireless technologies). In an exemplary embodiment, the controller 110 and the supply air flow station 124 transmit data to the user system 102, and receive instructions from the user system 102, as will be described herein.

In an embodiment, the exhaust components (e.g., hoods, ductwork 132, riser 130, and exhaust fan 128, etc.), in conjunction with the supply air components (e.g., supply air flow station 124 and supply air fan 126) make up the building's 101 air flow management system described herein.

In an exemplary embodiment, the interior building air pressure is controlled by balancing the exhaust removed from the building 101 with the supply air entering the building 101 via control logic 120 executed by the user system 102. The user system 102 receives input signals from the exhaust devices 104 and air flow station 124. It sends control signals to the exhaust dampers 122, supply fan 126, and exhaust fan 128 to balance the building pressure.

In an exemplary embodiment, the control logic 120 may be configured by an individual to define conditions (e.g., a minimum acceptable or threshold level of chemical that may be present at a work station or a combination of workstations serviced by corresponding exhaust devices 104), such that when the control logic 102 determines from data received from the controllers 110 that a condition has been met, the control logic 120 modifies the operation of one or more of the exhaust devices 104 and the supply air fan 126 to achieve a desired result.

The control logic 120 may also be configured to react to the absence of a user at a hood. If the presence detector 112 identifies no activity after a defined period of time, the controller 110 will command the sash motor 118 to close the sash 114. This prepares the hood for an energy saving mode. The controller 110 then commands the damper 122 to close which reduces the exhaust flow and enables energy savings as the air supplied to the building by supply air fan 126 is then reduced via the user system 102.

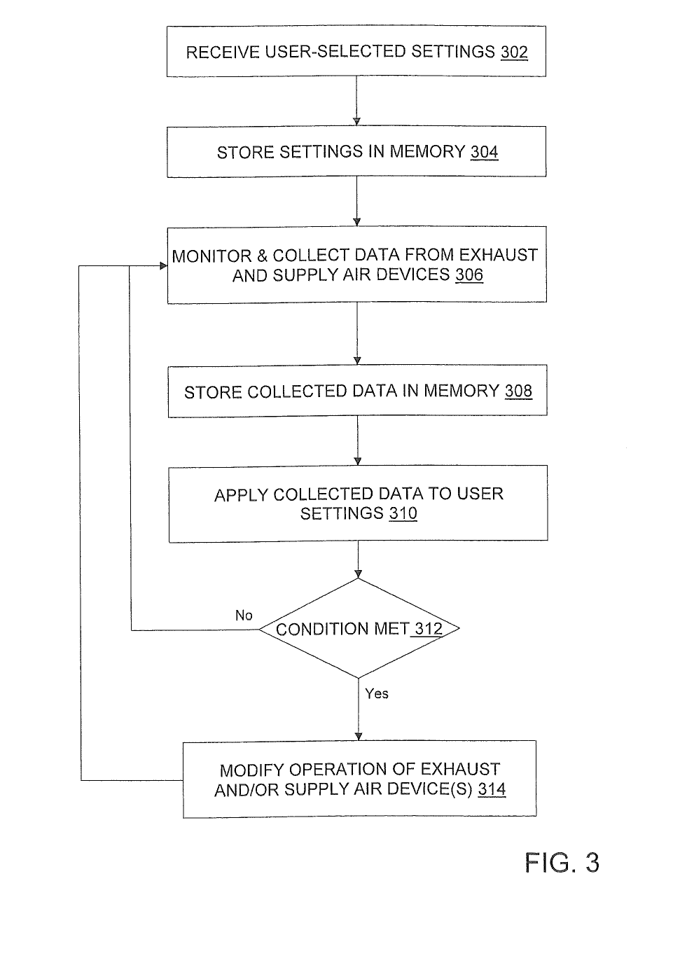

The user system 102 includes storage (not shown) for storing data acquired by the energy efficient air flow processes. In an embodiment, the control logic 120 logs various types of data, such as exhaust device 104 usage information received from the controllers 110 over time and uses this history information to determine a course of action. Turning now to FIG. 3, a process for implementing the energy efficient air flow will now be described in an exemplary embodiment.

At step 302, an authorized individual enters settings or preferences into the user system 102 via the control logic 120. As indicated above, a user may define conditions the occurrence of which cause the control logic 120 to modify the operational state of one or more of the exhaust devices 104. In addition, a user may define conditions the occurrence of which cause the control logic to modify the operational state of one or more of the building air supply devices 126. For example, the user may define a maximum acceptable or threshold level of chemical that may be present in the work area of one or a combination of exhaust devices 104. Alternatively, or additionally, the user may define a maximum number of exhaust devices 104 for which corresponding dampers 122 should be opened based on historical usage data of the exhaust devices 104. For example, suppose out of five work stations (i.e., five exhaust devices 104 shown in FIG. 1), only two are typically used at any given time according to the historical usage data. The control logic 120 may be configured via the user-selected settings to maintain an open state for dampers of two of the five exhaust devices 104 (where two of the five dampers correspond to the two that are actively in use).

Referring to FIG. 3, at step 304, the user-selected settings are stored, e.g., in memory of the user system 102.

At step 306, the control logic 120 collects data from the exhaust devices 104 (including exhaust flow sensors 134 and chemical sensors (not shown)), such as chemical concentrations in the air flow, volumetric flow, current operational state (e.g., damper open/closed or exhaust on/off). The control logic also collects data from the air supply devices including the air supply flow station 124 and supply air fan 126, such as supply air volumetric flow, fan speeds, etc. This information may be logged over time and stored as historical use data in the memory of the user system 102 at step 308, as described above.

At step 310, the control logic 120 applies the collected data to the user-selected settings. At step 312, the control logic 120 determines if a condition is met with regard to application of the collected data to the user-selected settings. If not, the process returns to step 306 whereby the control logic 120 continues to collect data. Otherwise, if a condition has been met, the control logic 120 modifies the operation of one or more of the exhaust devices 104 and/or air supply devices 124/126 based on the nature of the condition and the particular user settings. In one example, the control logic 120 may instruct one or more of the dampers 122 to open or close via the corresponding controllers 110 and network switch 106.

The process returns to step 306 whereby the control logic 120 continues to monitor and collect data from the exhaust devices 104 and air supply devices 124 and 126.

Technical effects of the invention provide an energy efficient air flow system and method. The energy efficient air flow system networks together exhaust devices disposed within a contained or enclosed environment (e.g., a designated area such as a building, floor, etc.) and automates the operation of the networked exhaust devices in terms of maintaining a desired level of air quality, while balancing positive and negative air flow conditions caused by the combined use of the exhaust devices and building supply air fans. The energy efficient air flow system utilizes a damper on the exhaust device as a control valve to effectively regulate both exhaust and air supply functions. As exhaust leaving the building can be reduced, so can the introduction of unconditioned air. Energy costs required to condition excess supply air can thus be avoided.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A system, comprising:
a plurality of exhaust devices disposed in an area defined by a building air flow management system, each of the plurality of exhaust devices having a controller operative to control functions of respective exhaust devices;
a first sensor communicatively coupled to each of the plurality of exhaust devices and respective controllers;
a computer communicatively coupled to the plurality of exhaust devices via respective controllers;
a second sensor configured to determine a fan speed of a supply air fan, the second sensor communicatively coupled to the computer; and
logic executable by the computer, the logic configured to implement a method, the method comprising:
receiving, at the computer, user-selected settings for controlling operation of the plurality of exhaust devices;
collecting data from the controllers via corresponding first sensors and from the second sensors;
applying the data to the user-selected settings; and
modifying operation of the building air flow management system via a respective controller of the at least one of the plurality of exhaust devices when, responsive to the applying, it is determined that a condition defined in the user-selected settings is met.

2. The system of claim 1, wherein the first sensor includes an exhaust flow sensor, the second sensor includes a supply air flow sensor, and the modifying operation of building air flow management system includes modifying a position of at least one of a damper valve on at least one of the plurality of exhaust devices and the supply air flow fan, the modifying configured to balance an amount of air flow coming in to the area as measured by the second sensor with an amount of exhaust air flow leaving the area as measured by the first sensor for each of the plurality of exhaust devices.

3. The system of claim 1, wherein the first sensor includes a sash position sensor and an exhaust flow sensor, the second sensor includes a supply air flow sensor, and the modifying operation of the building air flow management system includes modifying a position of at least one of a sash on at least one of the plurality of exhaust devices and the supply air flow fan, the modifying configured to balance an amount of air flow coming in to the area as measured by the second sensor with an amount of exhaust air flow leaving the area as measured by the exhaust flow sensor for each of the plurality of exhaust devices.

4. The system of claim 3, wherein the first sensor also includes a user presence detection sensor, and the modifying operation of the building air flow management system includes modifying a position of at least one of the sash and a damper valve on at least one of the plurality of exhaust devices responsive to determining an absence of an operator at the at least one of the plurality of exhaust devices.

5. The system of claim 1, wherein the computer stores historical usage data with respect to operations conducted by the plurality of exhaust devices via the collected data, and the modifying operation of the building air flow management system includes modifying a position of at least one of a sash and a damper on at least one of the plurality of exhaust devices and the supply air flow fan, the modifying configured to balance an amount of air flow coming in to the area as measured by the second sensor with an amount of exhaust air flow leaving the area as measured by the exhaust flow sensor for each of the plurality of exhaust devices.

6. The system of claim 1, wherein the computer is communicatively coupled to the controllers over a wireless network.

7. A method, comprising:
receiving, at a computer, user-selected settings for controlling operation of a plurality of exhaust devices, each of the plurality of exhaust devices disposed in an area defined by a building air flow management system and having a controller operative to control functions of respective exhaust devices, wherein a first sensor is communicatively coupled to each of the plurality of exhaust devices and respective controllers, and a second sensor is communicatively coupled to the computer and configured to determine a fan speed of a supply air fan;
collecting, via logic executable by the computer, data from the controllers via corresponding first sensors and from the second sensors;
applying the data to the user-selected settings; and
modifying operation of the building air flow management system via a respective controller of the at least one of the plurality of exhaust devices when, responsive to the applying, it is determined that a condition defined in the user-selected settings is met.

8. The method of claim 7, wherein the first sensor includes an exhaust flow sensor, the second sensor includes a supply air flow sensor, and the modifying operation of building air flow management system includes modifying a position of at least one of a damper valve on at least one of the plurality of exhaust devices and the supply air flow fan, the modifying configured to balance an amount of air flow coming in to the area as measured by the second sensor with an amount of exhaust air flow leaving the area as measured by the first sensor for each of the plurality of exhaust devices.

9. The method of claim 7, wherein the first sensor includes a sash position sensor and an exhaust flow sensor, the second sensor includes a supply air flow sensor, and the modifying operation of the building air flow management system includes modifying a position of at least one of a sash on at least one of the plurality of exhaust devices and the supply air flow fan, the modifying configured to balance an amount of air flow coming in to the area as measured by the second sensor with an amount of exhaust air flow leaving the area as measured by the exhaust flow sensor for each of the plurality of exhaust devices.

10. The method of claim 9, wherein the first sensor also includes a user presence detection sensor, and the modifying operation of the building air flow management system includes modifying a position of at least one of the sash and a damper valve on at least one of the plurality of exhaust devices responsive to determining an absence of an operator at the at least one of the plurality of exhaust devices.

11. The method of claim 7, wherein the computer stores historical usage data with respect to operations conducted by the plurality of exhaust devices via the collected data, and the modifying operation of the building air flow management system includes modifying a position of at least one of a sash and a damper on at least one of the plurality of exhaust devices and the supply air flow fan, the modifying configured to balance an amount of air flow coming in to the area as measured by the second sensor with an amount of exhaust air flow leaving the area as measured by the exhaust flow sensor for each of the plurality of exhaust devices.

12. The method of claim 7, wherein the computer is communicatively coupled to the controllers over a wireless network.

13. A computer program product comprising a storage medium having instructions embodied thereon, which when executed by a computer cause the computer to implement a method, the method comprising:
receiving user-selected settings for controlling operation of a plurality of exhaust devices, each of the plurality of exhaust devices disposed in an area defined by a building air flow management system and having a controller operative to control functions of respective exhaust devices, wherein a first sensor is communicatively coupled to each of the plurality of exhaust devices and respective controllers, and a second sensor is communicatively coupled to the computer and configured to determine a fan speed of a supply air fan;
collecting data from the controllers via corresponding first sensors and from the second sensors;
applying the data to the user-selected settings; and
modifying operation of the building air flow management system via a respective controller of the at least one of the plurality of exhaust devices when, responsive to the applying, it is determined that a condition defined in the user-selected settings is met.

14. The computer program product of claim 13, wherein the first sensor includes an exhaust flow sensor, the second sensor includes a supply air flow sensor, and the modifying operation of building air flow management system includes modifying a position of at least one of a damper valve on at least one of the plurality of exhaust devices and the supply air flow fan, the modifying configured to balance an amount of air flow coming in to the area as measured by the second sensor with an amount of exhaust air flow leaving the area as measured by the first sensor for each of the plurality of exhaust devices.

15. The computer program product of claim 13, wherein the first sensor includes a sash position sensor and an exhaust flow sensor, the second sensor includes a supply air flow sensor, and the modifying operation of the building air flow management system includes modifying a position of at least one of a sash on at least one of the plurality of exhaust devices and the supply air flow fan, the modifying configured to balance an amount of air flow coming in to the area as measured by the second sensor with an amount of exhaust air flow leaving the area as measured by the exhaust flow sensor for each of the plurality of exhaust devices.

16. The computer program product of claim 15, wherein the first sensor also includes a user presence detection sensor, and the modifying operation of the building air flow management system includes modifying a position of at least one of the sash and a damper valve on at least one of the plurality of exhaust devices responsive to determining an absence of an operator at the at least one of the plurality of exhaust devices.

17. The computer program product of claim 13, wherein the computer stores historical usage data with respect to operations conducted by the plurality of exhaust devices via the collected data, and the modifying operation of the building air flow management system includes modifying a position of at least one of a sash and a damper on at least one of the plurality of exhaust devices and the supply air flow fan, the modifying configured to balance an amount of air flow coming in to the area as measured by the second sensor with an amount of exhaust air flow leaving the area as measured by the exhaust flow sensor for each of the plurality of exhaust devices.

18. The computer program product of claim 13, wherein the computer is communicatively coupled to the controllers over a wireless network.
